(19) United States
(12) Patent Application Publication
(10) Pub. No.: US 2025/0342650 A1
(43) Pub. Date: Nov. 6, 2025

(54) LIVE NEURAL RECONSTRUCTION ON EDGE DEVICES

(71) Applicant: QUALCOMM Incorporated, San Diego, CA (US)

(72) Inventors: Jihong JU, Amsterdam (NL); Mohsen GHAFOORIAN, Diemen (NL); Oleksandr BAILO, Amsterdam (NL); Shang-Lun LEE, Taipei City (TW); Yu FU, Taipei City (TW); Abhijeet BISAIN, San Diego, CA (US); Gerhard REITMAYR, Del Mar, CA (US)

(21) Appl. No.: 18/652,733

(22) Filed: May 1, 2024

(51) Int. Cl. G06T 15/08; G06T 7/50

(52) U.S. Cl. CPC G06T 15/08; G06T 7/50; G06T 2207/10028; G06T 2207/20084

(57) ABSTRACT

Aspects presented herein may improve the overall performance of three-dimensional (3D) scene reconstruction on edge devices by enabling a fast high fidelity 3D reconstruction for edge devices. In one aspect, a UE receives, from a camera, a stream of posed images. The UE updates, based on each posed image in the stream of posed images, a feature volume recursively. The UE updates, based on the updated feature volume, a truncated signed distance function (TSDF) volume. The UE outputs an indication of the updated TSDF volume. In some example, the UE may also receive a stream of depth maps associated with the stream of posed images, and the TSDF volume may be updated further based on the stream of depth maps.

### TECHNICAL FIELD

The present disclosure relates generally to image processing systems, and more particularly, to image processing involving scene reconstruction.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives, from a camera, a stream of posed images. The apparatus updates, based on each posed image in the stream of posed images, a feature volume recursively. The apparatus updates, based on the updated feature volume, a truncated signed distance function (TSDF) volume. The apparatus outputs an indication of the updated TSDF volume.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example communication between a server, a base station, and one or more UEs in accordance with various aspects of the present disclosure.

FIG. 5 is a diagram illustrating an example of a list of components in an extended reality (XR) headset in accordance with various aspects of the present disclosure.

FIG. 6 is a diagram illustrating an example collision warning for a virtual reality (VR) headset/application using three-dimensional (3D) mesh in accordance with various aspects of the present disclosure.

FIG. 7 is a diagram illustrating an example realistic rendering using 3D mesh in accordance with various aspects of the present disclosure.

FIG. 8A is a diagram illustrating one example of a live neural reconstruction on edge devices in accordance with various aspects of the present disclosure.

FIG. 8B is a diagram illustrating another example of a live neural reconstruction on edge devices in accordance with various aspects of the present disclosure.

FIG. 9 is a diagram illustrating an example of a live neural reconstruction on edge devices in accordance with various aspects of the present disclosure.

FIG. 10 is a diagram illustrating an example of an edge device performing live update of a truncated signed distance function (TSDF) volume of interest given a stream of images and camera poses in accordance with various aspects of the present disclosure.

FIG. 11 is a diagram illustrating an example of an edge device performing live update of a TSDF volume of interest given a stream of images and camera poses in accordance with various aspects of the present disclosure.

FIG. 12 is a diagram illustrating an example of an edge device performing live update of a TSDF volume of interest given a stream of images and camera poses in accordance with various aspects of the present disclosure.

FIG. 13 is a diagram illustrating an example of an edge device performing live update of a TSDF volume of interest given a stream of images and camera poses in accordance with various aspects of the present disclosure.

FIG. 14 is a diagram illustrating an example of backprojecting features on a two-dimensional (2D) image to a 3D space in accordance with various aspects of the present disclosure.

FIG. 15A is a diagram illustrating an example of covering a frustum with bigger fragments in accordance with various aspects of the present disclosure.

FIG. 15B is a diagram illustrating an example of covering a frustum with smaller fragments in accordance with various aspects of the present disclosure.

FIG. 16 is a flowchart of a method of wireless communication.

FIG. 17 is a diagram illustrating an example of a hardware implementation for an example apparatus and/or network entity.

### DETAILED DESCRIPTION

Aspects presented herein may improve the overall performance of three-dimensional (3D) scene reconstruction on edge devices by enabling a fast high fidelity 3D reconstruction for edge devices. Aspects presented herein may enable edge devices to update a feature within the frustum of each frame to enable the processing of a stream of images with high frequency. Aspects presented herein may also enable edge devices to update truncated signed distance function (TSDF) for just an observed region at an adaptive frequency, where the TSDF update may be configured to be more frequent in the beginning and less often after the scene has been fully observed (or the observation has exceeded a defined threshold). With the adaptive update strategy discussed herein, users of the edge devices may be able to observe reconstructed surfaces with low latency while the power consumption may remain low for the edge devices.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

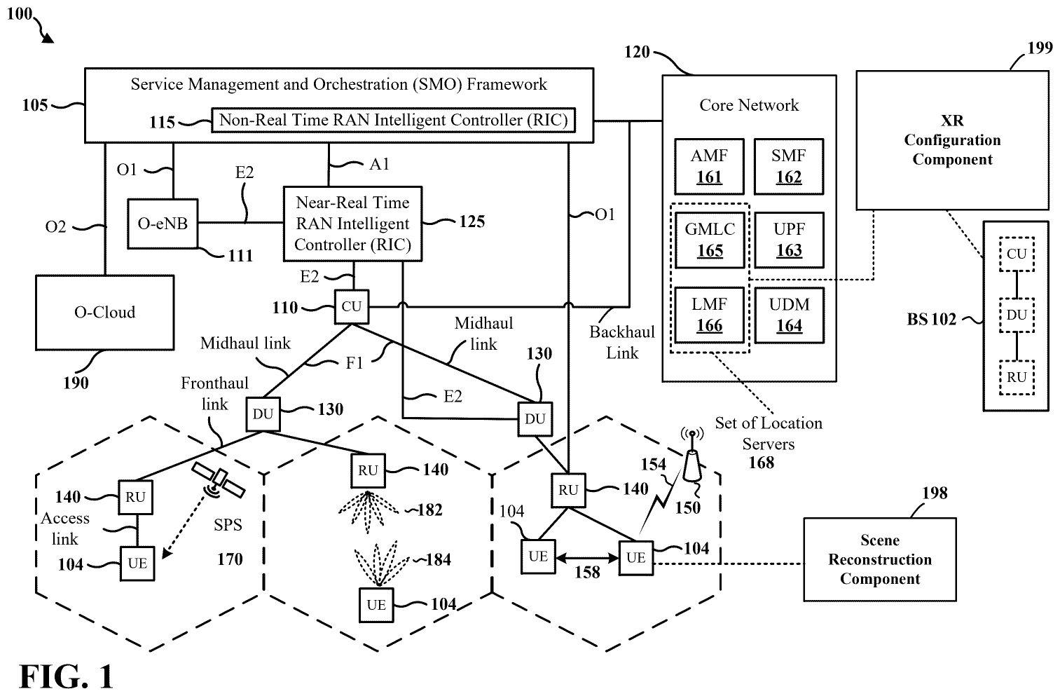

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 (e.g., an extended reality (XR) headset) may have a scene reconstruction component 198 that may be configured to receive, from a camera, a stream of posed images; update, based on each posed image in the stream of posed images, a feature volume recursively; update, based on the updated feature volume, a truncated signed distance function (TSDF) volume; and output an indication of the updated TSDF volume. In certain aspects, the base station 102 or the one or more location servers 168 may have an XR configuration component 199 that may be configured to provide (pre-)configuration(s) related to XR for the UE 104.

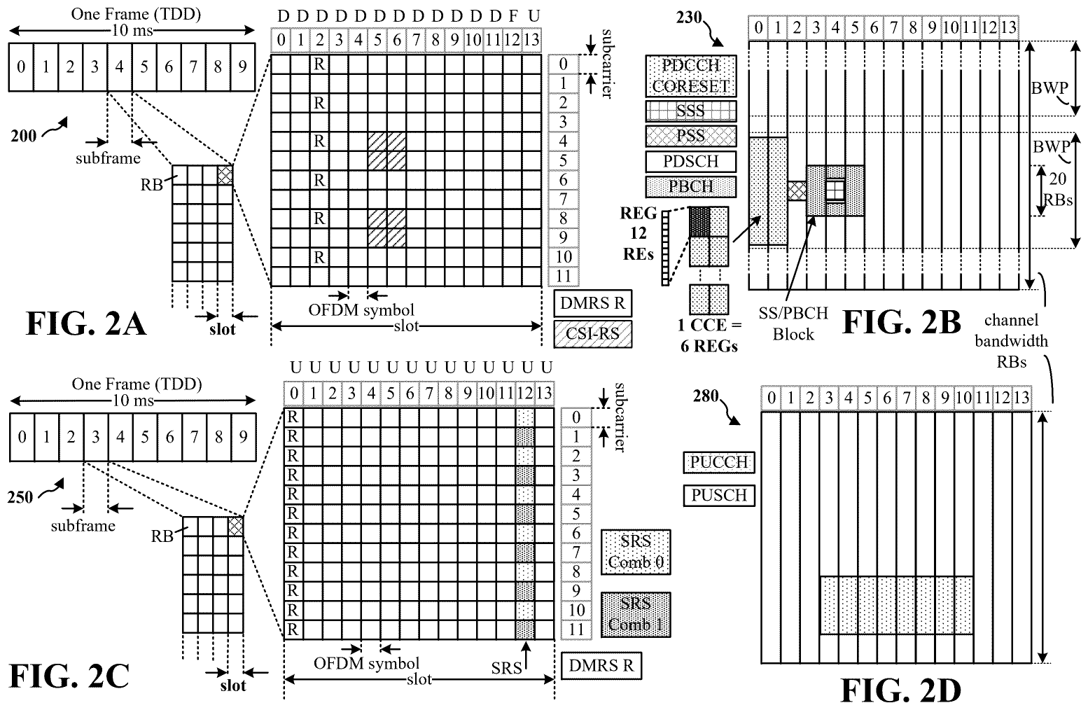

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

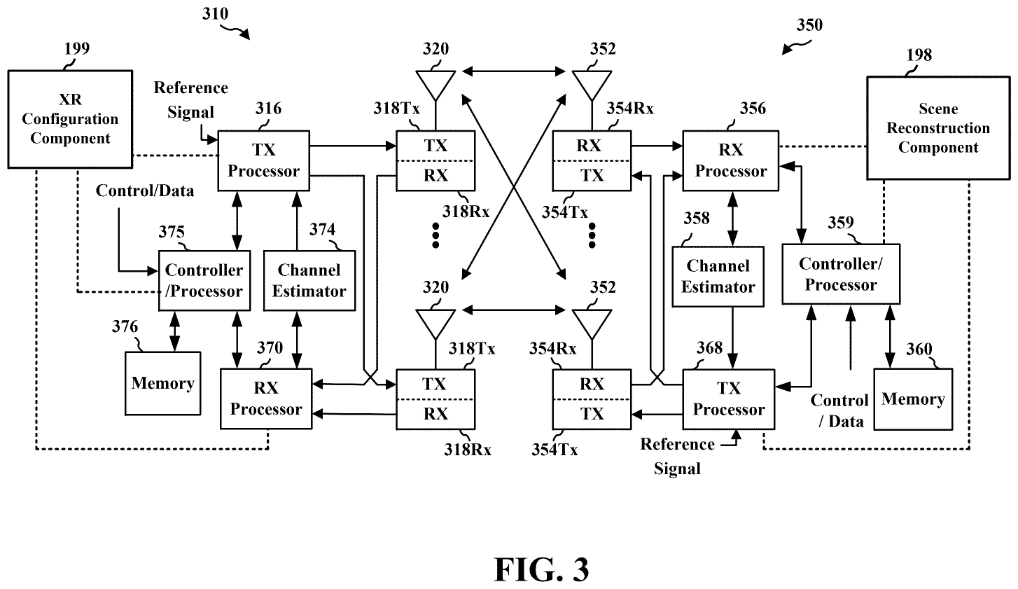

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the scene reconstruction component 198 of FIG. 1.

At least one of the TX processor 316, the RX processor 370, and the controller/processor 375 may be configured to perform aspects in connection with the XR configuration component 199 of FIG. 1.

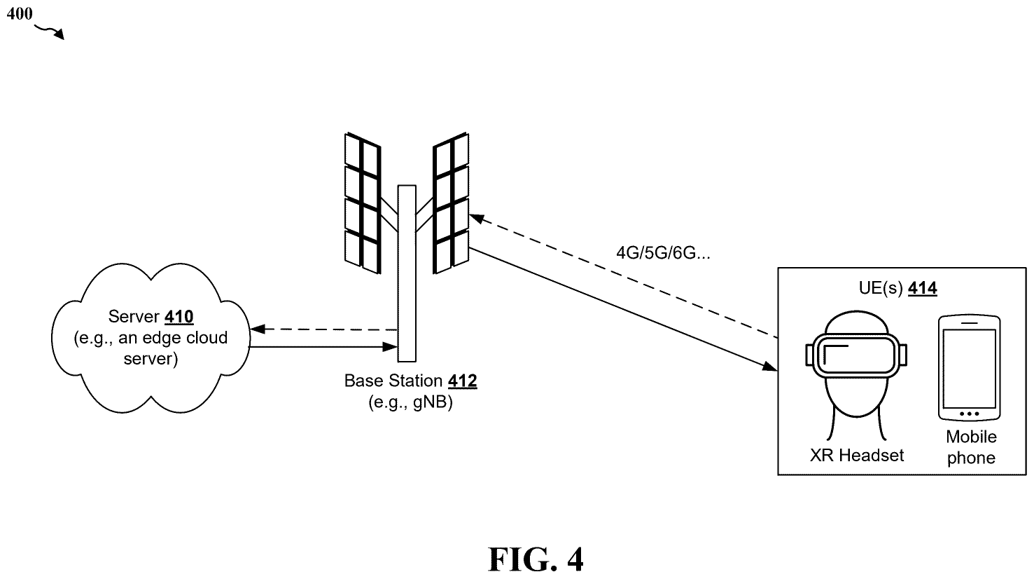

FIG. 4 is a diagram 400 illustrating an example communication between a server 410, a base station 412, and one or more UEs 414 in accordance with various aspects of the present disclosure. With improvements to the transmission (Tx) and reception (Rx) speed, latency, and/or the reliability of wireless communications (e.g., 4G LTE, 5G NR, 6G, etc.) over the last few years, various devices and applications have been designed and configured to take advantage of these improvements. As such, some devices/applications may have very tight/strict specifications for wireless communication. For example, extended reality (XR) applications and certain mobile devices (collectively as UEs) may have very tight specifications for latency and power, such as specifying a packet delay budget to be less than 10 milliseconds (ms) and/or a power consumption to be less than 1 Watt (W), etc. For purposes of the present disclosure, XR may refer to technologies that combine the physical and digital worlds, creating immersive and interactive environments for users. XR may be an umbrella term that encompasses virtual reality (VR), augmented reality (AR), and/or mixed reality (MR).

In some scenarios, XR may also be associated/implemented with video see-through (VST) technology to seamlessly blend the physical and virtual worlds to provide users with an immersive and interactive experience. In VST, a camera may be configured to capture a digital video image (which may be referred to as a “frame”) of the real world and transfers it to the graphics processor in real-time. Then the graphics processor (which may also be referred to as an “image signal processor (ISP)”) may combine the video image feed with computer-generated images (e.g., a virtual content) and displays it on a screen (e.g., a screen on an XR headset). As such, VST may refer to the integration of live video feed from a user's perspective into the XR environment. VST may be employed in various applications across industries, including gaming, education, healthcare, and industrial training.

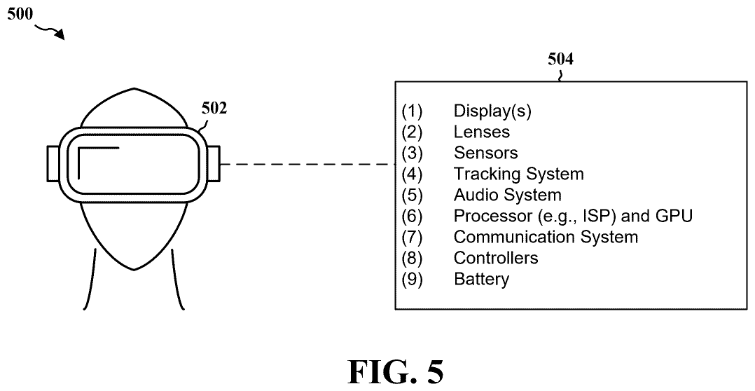

FIG. 5 is a diagram 500 illustrating an example of a list of components in an XR headset in accordance with various aspects of the present disclosure. As shown at 504, an XR headset 502 (which may also be referred to as a UE for purposes of the present disclosure) may include one or more of the following components:
(1) Display(s): an XR headset may include one or more high-resolution displays for rendering virtual and/or augmented content. These displays may be positioned close to the user's eyes to create an immersive field-of-view (FOV).
(2) Lenses: an XR headset may include a set of lenses that is used to focus and shape the light coming from the display(s), enhancing the quality of the virtual and/or augmented images. The lenses may also be used for determining the field of view and minimizing distortion.
(3) Sensors: an XR headset may include various sensors to track the user's movements and positions. Sensors may include an inertial measurement unit (IMU), an accelerometer, a gyroscope, a magnetometer, and sometimes one or more external tracking systems (e.g., external cameras and/or sensors placed in the environment).
(4) Tracking System: an XR headset may include an internal and/or an external tracking system that is capable of monitoring the position and the orientation of the XR headset.
(5) Audio System: an XR headset may include a built-in audio system or a headphone jack to provide audio to the user.
(6) Processor (e.g., ISP) and/or GPU: an XR headset may include at least one processor and/or graphics processing unit (GPU) to handle the rendering of complex virtual environments or augmentations.
(7) Communication System: an XR headset may include a set of wired and/or wireless connectivity options to connect the XR headset to external devices, networks, or controllers, which may include USB ports, Bluetooth®, 4G/5G wireless network, and/or Wi-Fi capabilities, etc.
(8) Controllers: an XR headset may include a set of controllers that enables the user to interact with the virtual environment. These controllers may include buttons, triggers, and sometimes haptic feedback for a more immersive experience.
(9) Battery: an XR headset may include a set of rechargeable batteries to power the XR headset during use.

In some implementations, to enable seamless interaction between the human, environment, and computers for XR applications, an XR headset/application may be configured to reconstruct the environment surrounding the XR headset. As such, the user of the XR headset may avoid colliding with physical objects in surrounding environments, such as furniture, walls, and/or other users, etc.

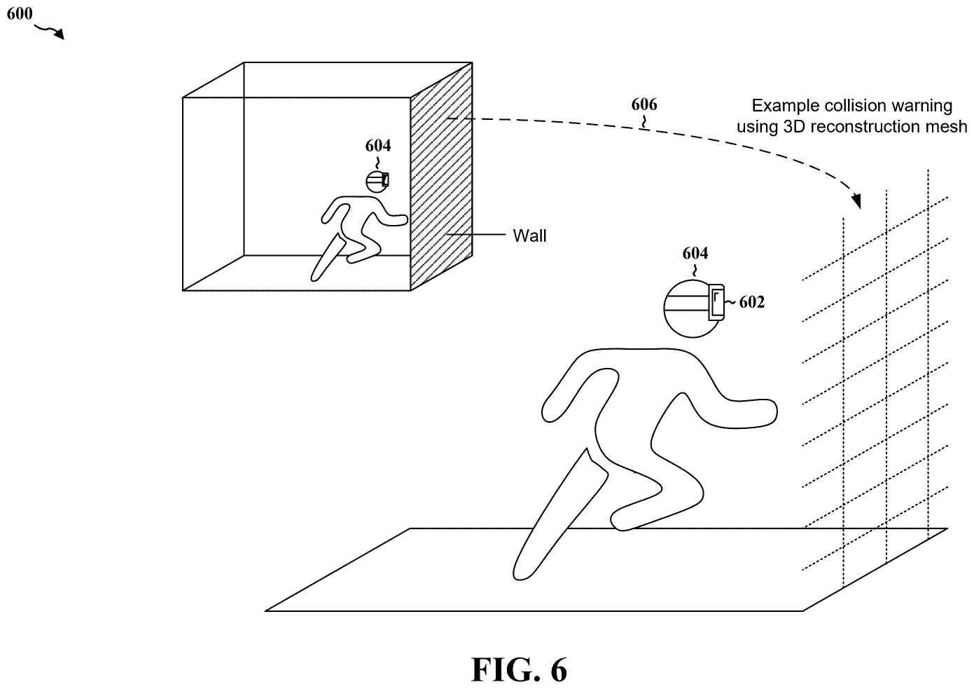

FIG. 6 is a diagram 600 illustrating an example collision warning for a VR headset/application using three-dimensional (3D) mesh in accordance with various aspects of the present disclosure. In one example, a VR headset 602 may include a collision warning mechanism that uses a 3D scene reconstruction to prevent a user 604 from colliding into walls or furniture. For example, as shown at 606, the VR headset 602 may detect a wall ahead of the user 604, and may warn the user 604 of the wall by showing the wall to the user 604 (e.g., via the display(s) of the VR headset 602) using the virtual mesh.

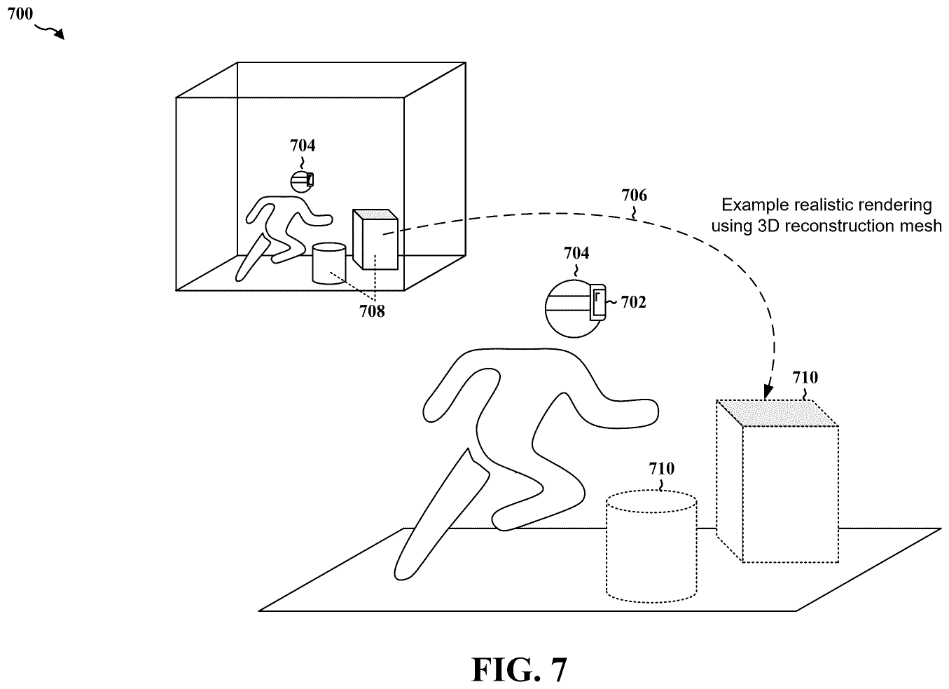

FIG. 7 is a diagram 700 illustrating an example realistic rendering using 3D mesh in accordance with various aspects of the present disclosure. In another example, an AR/MR headset 702 may include a realistic rendering mechanism that uses a 3D scene reconstruction to render virtual objects in a 3D environment to prevent a user 704 from colliding into walls or furniture. For example, as shown at 706, the AR/MR headset 702 may detect a set of physical objects 708 surrounding the user 704, and may show the set of physical objects 708 (e.g., via the display(s) of the AR/MR headset 702) in virtual forms 710. In other words, the user 704 may see the set of physical objects 708 in meshes that corresponding to the set of physical objects 708 around the user 704.

Truncated signed distance function (TSDF) integration is one of techniques that may be used by an XR headset (e.g., a VR/AR/MR headset) for performing the 3D scene reconstruction. TSDF integration is a method for representing and updating a 3D volumetric model of a scene using depth information obtained from sensors like depth cameras and/or lidar (e.g., it uses a depth map as the input). TSDF integration may include the following concepts:
(1) Signed Distance Function (SDF): an SDF may be a mathematical representation of a shape or surface in 3D space, which assigns each point in the 3D space with a signed distance value, where the sign indicates whether the point is inside or outside the surface. If the point is on the surface, the distance is zero.
(2) Truncation: in some scenarios, depth measurements may contain noise or outliers. Truncation may be used for limiting the influence of erroneous depth measurements. TSDF may maintain a truncated region around the surface, and depth measurements beyond this region may be ignored during integration.
(3) Integration: TSDF integration may involve updating the 3D volumetric representation of the scene by incorporating new depth measurements. For each depth measurement from a sensor, the corresponding voxel in the volumetric grid is updated based on the observed depth and the current TSDF value. This process may help refine the representation of the scene over time.
(4) Volumetric Grid: a scene may be discretized into a 3D grid of voxels, where each voxel may store information about the scene's geometry, such as the TSDF value, color, or other attributes.

TSDF integration may be useful for 3D scene reconstruction on an edge device as it allows for real-time updates and refinement of the 3D model, making it well-suited for applications where dynamic scenes or objects are specified to be accurately captured and represented. However, while TSDF integration may enable fast 3D scene reconstruction on edge devices, it does not have high-fidelity (e.g., it may not reconstruct the 3D scene accurately). For example, TSDF integration may lack reasoning capability in 3D as it is sensitive to depth errors and is likely to be affected by missing surfaces in occluded/unobserved regions. As such, TSDF integration may create distracting phenomena, such as ghost walls and/or noisy bulks in the air which block views, and holes in the floor which may trap virtual avatar and objects. For purposes of the present disclosure, an edge device may refer to an endpoint on the network, the interface between the data center and the real world. Examples of an edge devices may include an XR headset (e.g., a VR/AR/MR headset), a UE, a smartphone, or a gaming console, etc.

Another technique that may be used by an XR headset for 3D scene reconstruction is using neural reconstruction network(s). In the context of 3D scene reconstruction, a neural reconstruction or a neural reconstruction network may refer to the use of neural networks or deep learning techniques to reconstruct 3D representations of a scene from input data, such as images or point clouds. The general process of neural reconstruction for 3D scene reconstruction may involve training a neural network on a dataset containing pairs of input images (or other sensor data) and corresponding ground truth 3D representations of the scene. Then, the neural network may learn to infer the 3D structure of the environment from the 2D input data (e.g., from images captured by the camera of the XR headset). Key components of the neural reconstruction in 3D scene reconstruction may include:
(1) Architecture: a neural network architecture may be designed to take 2D images or point clouds as input and produce a 3D representation of the scene as output. Convolutional neural networks (CNNs), recurrent neural networks (RNNs), or more advanced architectures like PointNet or VoxNet may be used depending on the nature of the input data.
(2) Training Data: large datasets with paired 2D and 3D data may be specified for training the neural network. The 3D data may include information about the geometry, depth, and structure of the scene.
(3) Loss Function: during training, a loss function may be defined to quantify the difference between the predicted 3D reconstruction and the ground truth. Common loss functions may include mean squared error or other metrics tailored to the specifics of the reconstruction task.
(4) Training Process: the neural network may be trained using optimization techniques to minimize the defined loss function. The trained network may then generalize to unseen data and reconstruct 3D scenes from new input.

Unlike the TSDF integration, a neural reconstruction network is capable of providing high-fidelity (e.g., it is capable of reconstructing the 3D scene accurately). However, it is also slower compared to the TSDF integration as it may take time to execute the neural network. Neural reconstruction network also has better 3D reasoning capability compared to the TSDF integration as it is able to refine erroneous surfaces and complete surfaces with holes. However, TSDF integration may be compute-intensive and memory-demanding as 3D CNN may scale cubically with input scene dimensions both in time and memory, and batch processing may delay reconstruction updates and increase peak memory usage. As such, a neural reconstruction network may sometimes crash due to out of memory error, and may be too slow to run on edge devices.

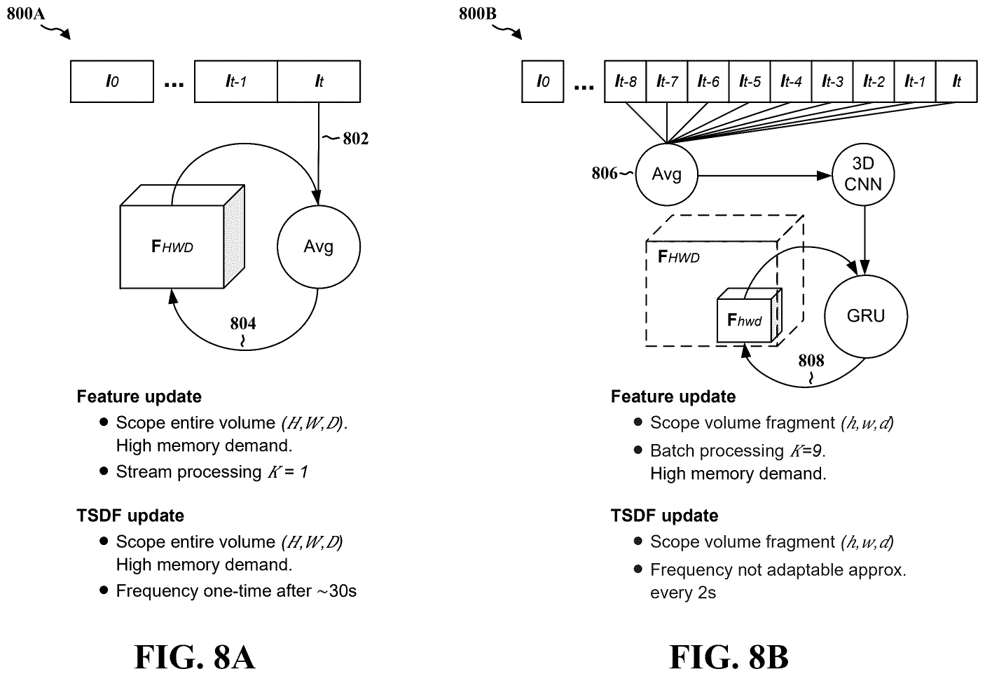

FIG. 8A is a diagram 800A illustrating one example of a live neural reconstruction on edge devices (e.g., on XR headsets, UEs, etc.) in accordance with various aspects of the present disclosure. In some implementations, as shown at 802, a neural reconstruction network may be configured to process a stream of images (e.g., images I₀ to Iₜ) related to a scene with one image being processed at a time (K=1), and convert/backproject features in the stream of images from a two-dimensional (2D) space to a three-dimensional (3D) space (e.g., to a 3D volume related to the scene). For purposes of the present disclosure, in the context of neural reconstruction, a “feature” may refer to a distinctive and/or meaningful representation extracted from a given input, such as an image or a set of images capturing a scene. These features may be used for understanding the content of the scene and also as input to the neural networks or other algorithms for reconstructing the 3D structure of the scene. A “feature volume” may refer to a volume that stores features. Then, as shown at 804, the neural reconstruction network may update features (F) of the entire 3D space/volume (e.g., a feature volume with height (H), width (W), and depth (D)) for each update, which may be denoted by F_{HWD}. As such, to perform the feature and TSDF update of a 3D space/volume, the neural reconstruction network may be specified to scope the entire 3D space/volume, which may specify high memory. The update may also take a longer time (e.g., approximately 30 seconds each time) as more data (e.g., features) may be specified to be stored and processed.

FIG. 8B is a diagram 800B illustrating another example of a live neural reconstruction on edge devices in accordance with various aspects of the present disclosure. In some implementations, a neural reconstruction network may be configured to process images related to a scene in batches, and convert/backproject features in the images from a 2D space to a 3D space (e.g., using a 3D CNN). For example, as shown at 806, for a set of images (e.g., I₀ to Iₜ) related to a scene, the neural reconstruction network may be configured to process a batch of K images at a time (e.g., nine images are processed at a time if K=9. Then, as shown at 808, the neural reconstruction network may update features (F) of a fragment (e.g., a portion, a subset, etc.) of the entire 3D space/volume for each update, where the feature volume of the entire 3D space may be denoted by F_{FWD} and the feature volume of the fragment may be denoted by F_{fwd}. As such, to perform the feature and TSDF update of a 3D space/volume, the neural reconstruction network may be specified to scope just a fragment of the entire 3D space/volume, which may use less memory compared to scoping the entire 3D space/volume as described in connection with FIG. 8A. The update may also take less time (e.g., approximately 2 seconds each time). However, batch processing of images may also specify high computational resources and memory, and the frequency of the update may not be adaptable.

Aspects presented herein may improve the overall performance of 3D scene reconstruction on edge devices by enabling a fast high fidelity 3D reconstruction for edge devices. Aspects presented herein may enable edge devices to update a feature within the frustum of each frame to enable the processing of a stream of images with high frequency. Aspects presented herein may also enable edge devices to update TSDF for just an observed region at an adaptive frequency, where the TSDF update may be configured to be more frequent in the beginning and less often after the scene has been fully observed (or the observation has exceeded a defined threshold). With the adaptive update strategy discussed herein, users of the edge devices may be able to observe reconstructed surfaces with low latency while the power consumption may remain low for the edge devices.

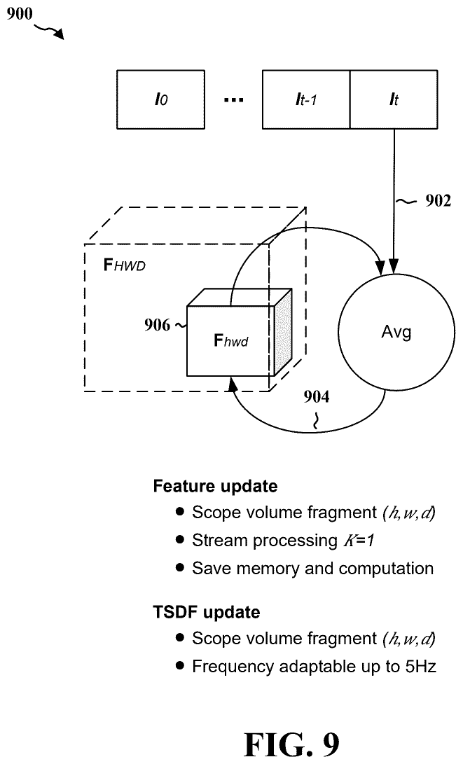

FIG. 9 is a diagram 900 illustrating an example of a live neural reconstruction on edge devices in accordance with various aspects of the present disclosure. In one aspect of the present disclosure, as shown at 902, a neural reconstruction network (which may be implemented at an edge device such as a UE, an XR headset, etc.) may be configured to process a stream of images (e.g., images I₀ to Iₜ) related to a scene with one image being processed at a time (e.g., K=1), and convert/backproject features in the stream of images from a 2D space to a 3D space (e.g., to a 3D volume related to the scene). Then, as shown at 904, the neural reconstruction network may update features (F) of a fragment of the entire 3D space/volume for each update. As such, to perform the feature and TSDF update of a 3D space/volume, the neural reconstruction network may be specified to scope just a fragment of the entire 3D space/volume at a time, which may use less memory compared to scoping the entire 3D space/volume as described in connection with FIG. 8A. Also, as just one image is being processed at a time, less computational resources and memory may be used compared to the batch processing of images as described in connection with FIG. 8B. The update may also take less time and the frequency of the update may be configured to be adaptable (e.g., the update frequency may be adaptable up to 5 Hz).

As shown at 906, the feature update scope may be within the frustum of each frame. Compared to the (seemingly unlimited) update scope described in connection with FIG. 8A, memory usage and computing specification for the model shown by FIG. 9 may have a more reasonable upper bound which does not grow with the scene size. For example, consider a 10×10×5 m³ scene, the feature volume may have a dimension (96, 256, 256) with 32 channels in each voxel (e.g., a voxel may represent a single sample, or data point, on a regularly spaced, three-dimensional grid). 750 megabytes (MB) of memory and 1.5 gigaflops (GFLOPS) may be saved if just a fragment of dimension (48, 48, 48) is updated each time. The bigger the scene is, the more memory and computation may be saved. Also, stream processing discussed in connection with FIG. 9 may be achieved using an efficient recursive feature update (discuss below). Compared to the batch processing discussed in connection with FIG. 8B, feature update using this model may become more frequent and memory usage may be saved from holding incoming data in batches. Power consumption may also be saved by avoiding using a 3D CNN and/or a gated recurrent unit (GRU) for feature aggregation.

In the context of TSDF update based on using the model discussed in connection with FIG. 9, the TSDF update scope is also constrained to the region with updated features. Without this constraint (e.g., as discussed in connection with FIG. 8A), running 3D CNN(s) may cause out-of-memory errors for most edge devices (e.g., AV/VR/MR glasses, smart phones, and laptops, etc.). In addition, TSDF update frequency may be adaptable due to frequent feature accumulation. The TSDF update may be configured to be executed more frequently (e.g., up to 5 Hz) when features change drastically and less frequently to save power when new observations do not bring new information.

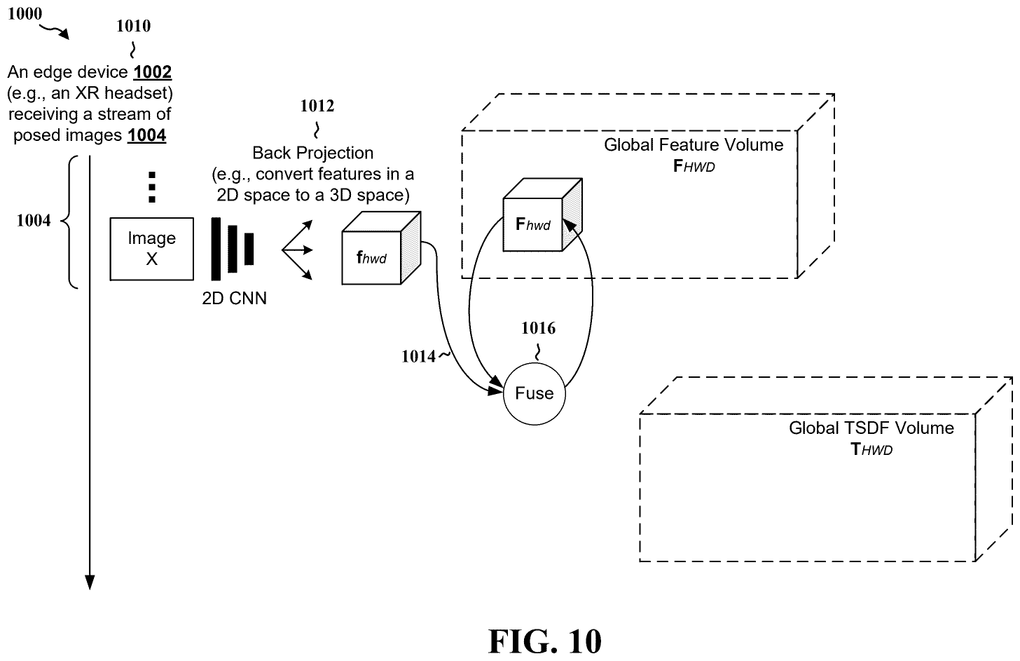

FIGS. 10 to 13 are diagrams 1000, 1100, 1200, and 1300, respectively, illustrating an example of an edge device performing live update of a TSDF volume of interest given a stream of images and camera poses in accordance with various aspects of the present disclosure. Referring to the diagram 1000 of FIG. 10, as shown at 1010, an edge device 1002 (e.g., an XR headset, a UE, etc.) may be configured to receive a stream of posed images 1004, such as from at least one camera. For purposes of the present disclosure, a posed image may refer to an image taken by a camera that also includes pose information of the camera when taken the image. A pose or a camera pose may refer to the position and orientation of a camera in a world coordinate system, with respect to six degrees of freedom (6DoF), using different representations, e.g., a transformation matrix.

Then, as shown at 1012, the edge device 1002 may convert a set of features that is extracted from each posed image in the stream of posed images 1004 to a 3D space based on a backprojection. For example, the edge device 1002 may extract a feature image from each posed image in the stream of posed images 1004 using a 2D CNN, and then construct a feature volume from the feature image extracted from each posed image based on a backprojection, where the constructed feature volume may be configured to be a fragment of a larger space (e.g., a region/volume/area of interest). For illustration purposes, this larger space may be referred to as a global volume, and features and TSDF within the global volume may be referred to as the global feature volume (F_{HWD}) and the global TSDF volume (T_{HWD}), respectively. A fragment of the global feature volume (F_{HWD}) and global TSDF volume (T_{HWD}) may be denoted by F_{hwd} and T_{hwd}, respectively. There may also be a one-to-one (1:1) mapping between the global feature volume (F_{HWD}) and global TSDF volume (T_{HWD}). After the posed image X is backprojected to a feature volume (f_{hwd}) that corresponds to the posed image X, this feature volume (f_{hwd}) may be outputted to a fusion module as shown at 1014. In some examples, the edge device 1002 may initialize a recursively updated feature volume with this feature volume that corresponds to the posed image X.

As shown at 1016, the fusion module may use this feature volume (f_{hwd}) to update the corresponding fragment (F_{hwd}) of the global feature volume (F_{HWD}). In other words, the fusion module may fuse the feature volume (f_{hwd}) from image X with the corresponding feature volume (F_{hwd}) in the global feature volume (F_{HWD}). The edge device 1002 may be configured to repeat this process for each posed image in the stream of posed images 1004. Depending on the implementations, the fusion/update may be based on running the average (e.g., between f_{hwd} and F_{hwd}), running the variance, or running both the average and the variance.

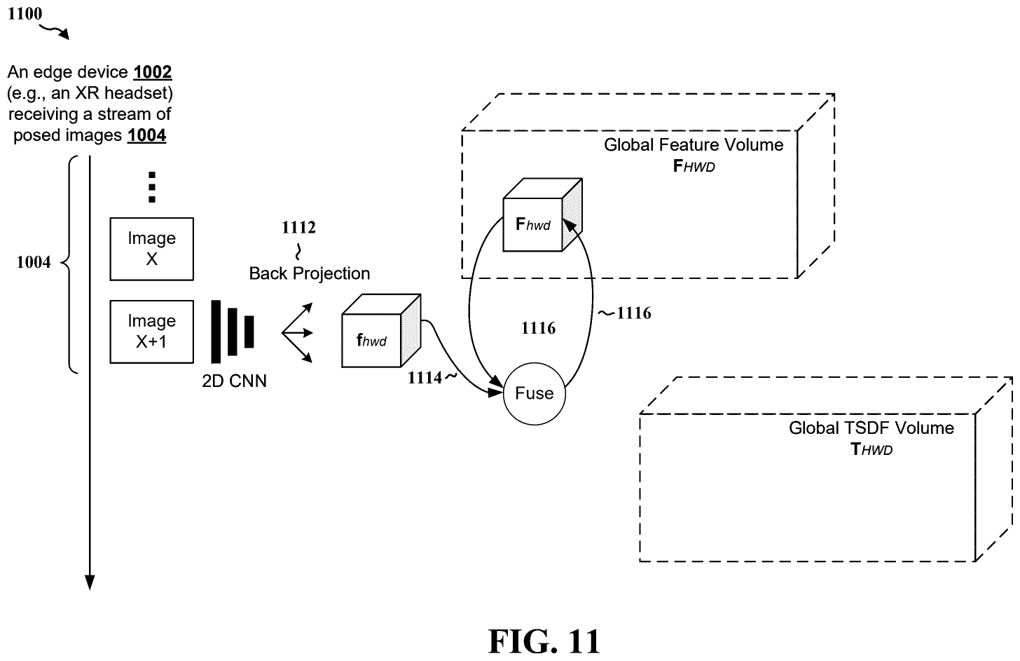

For example, referring to the diagram 1100 of FIG. 11. As shown at 1112, the edge device 1002 may backproject a set of features that is extracted from the next consecutive posed image X+1 to a 3D space (e.g., using the 2D CNN). After the extracted features of the posed image X+1 is backprojected to a feature volume (f_{hwd}) that corresponds to the posed image X+1, this feature volume (f_{hwd}) may be outputted to the fusion module as shown at 1114. The fusion module may then use this feature volume (f_{hwd}) to update the corresponding fragment (F_{hwd}) of the global feature volume (F_{HWD}), such as shown at 1116. In other words, the edge device 1002 may fuse the feature volume corresponding to the posed image X+1 with the initialized recursively updated feature volume corresponding to the posed image X (e.g., discussed in connection with 1014) to obtain an updated feature volume (F_{hwd}).

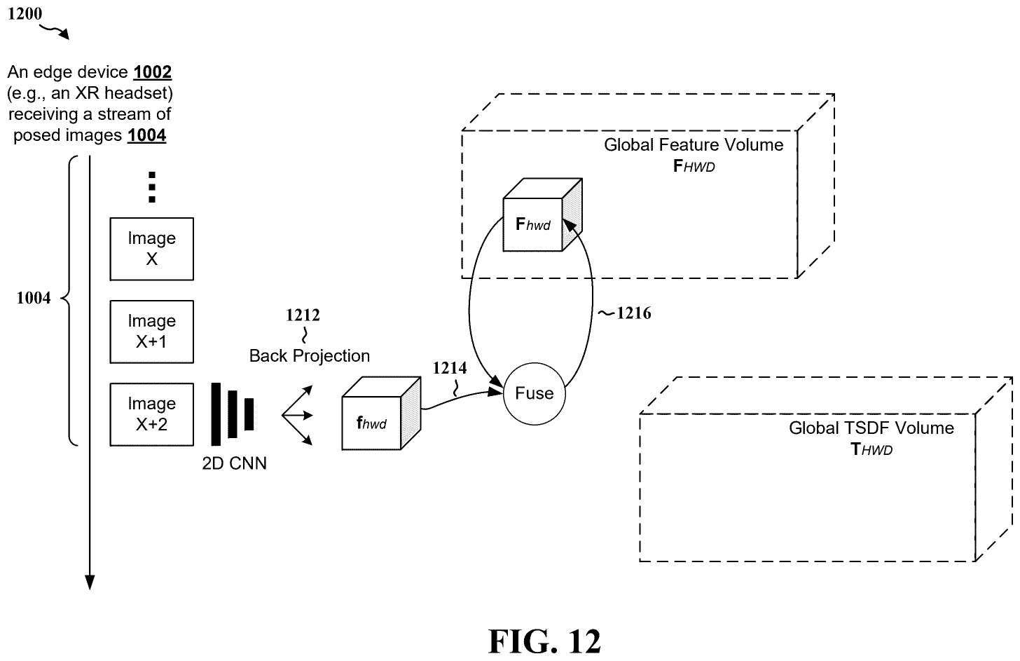

Similarly, referring to the diagram 1200 of FIG. 12. As shown at 1212, the edge device 1002 may backproject a set of features in the next consecutive posed image X+2 to a 3D space (e.g., using the 2D CNN). After the posed image X+2 is backprojected to a feature volume (f_{hwd}) that corresponds to the posed image X+2, this feature volume (f_{hwd}) may be outputted to the fusion module as shown at 1214. The fusion module may then use this feature volume (f_{hwd}) to update the corresponding fragment (F_{hwd}) of the global feature volume (F_{HWD}), such as shown at 1216. As such, based on the stream of posed images 1004, the edge device 1002 may update the feature volume (F_{hwd}) recursively (based on running the average and/or the variance). In some implementations, the edge device 1002 may also be configured to fuse a number of feature volumes (f_{hwd}) from multiple images before updating the feature volume (F_{hwd}) of the global feature volume (F_{HWD}). For example, the edge device 1002 may first fuse the feature volumes (f_{hwd}) associated with images X, X+1, and X+2, such as by taking their averages (Avg). Then, the edge device 1002 may use this fused/averaged feature volume (f_{hwd}) to update the corresponding feature volume (F_{hwd}) of the global feature volume (F_{HWD}).

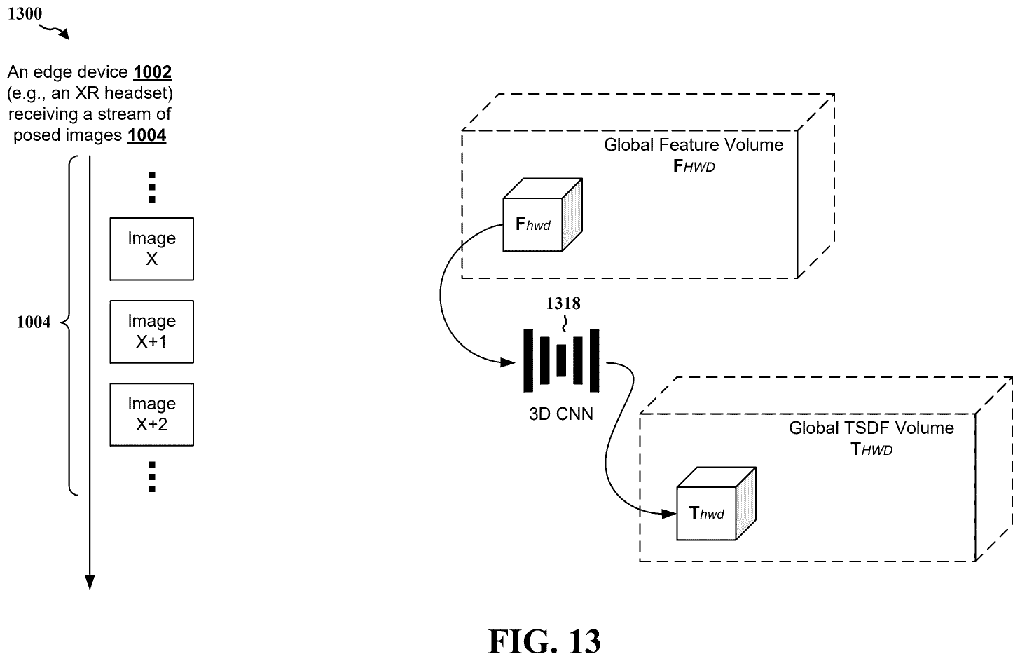

Referring to the diagram 1300 of FIG. 13, as shown at 1318, after the edge device 1002 updates the corresponding feature volume (F_{hwd}) of the global feature volume (F_{HWD}) based on the stream of posed images 1004, the edge device 1002 may use the updated feature volume (F_{hwd}) to update the corresponding TSDF volume (T_{hwd}) in the global TSDF volume (T_{HWD}) (e.g., there may be a one-to-one mapping between F_{hwd}/F_{HWD} and T_{hwd}/T_{HWD}). The edge device 1002 may perform this update using a 3D CNN (e.g., with the updated feature volume (F_{hwd}) as an input). Then, the edge device 1002 may output this updated TSDF volume (T_{hwd}), such as performing a 3D scene reconstruction based on the updated TSDF volume (T_{hwd}). In some examples, the edge device 1002 may also transmit and/or store (an indication of) the updated TSDF volume.

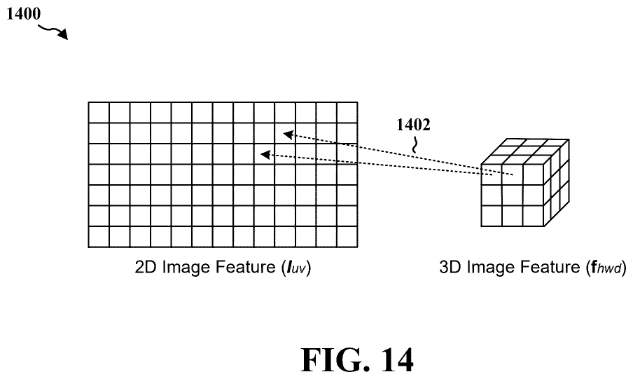

FIG. 14 is a diagram 1400 illustrating an example of backprojecting features on a 2D image to a 3D space in accordance with various aspects of the present disclosure. As shown at 1402, a 2D image feature (Iᵤᵥ) (e.g., an image including features, which may also be referred to as a 2D image feature map) may be transformed to a 3D image feature (f_{hwd}) (which may also be referred to as a 3D feature volume) based on f(ijk)=I(π(Pᵢⱼₖ)), where Pᵢⱼₖ is voxel ijk's 3D position, and π(·) projects 3D positions to 2D pixels. In some implementations, features to be backprojected from the 2D image to the 3D image include 2D CNN features and optionally the depth images. In addition, voxels involved in backprojection may be located inside a frame frustum. For purposes of the present disclosure and in the context of 3D computer graphics and computer vision, a depth image or a depth map may refer to an image or an image channel that contains information relating to the distance of the surfaces of scene objects from a viewpoint. A voxel may represent a value on a regular grid in a 3D space (e.g., similar to a pixel on a 2D bitmap). In the context of 3D computer graphics, a frustum or a viewing frustum may refer to a region of space in a modeled world that may appear on the screen, such as the field of view of a perspective virtual camera system. In some examples, a frustum may also refer to a part of space that is being observed.

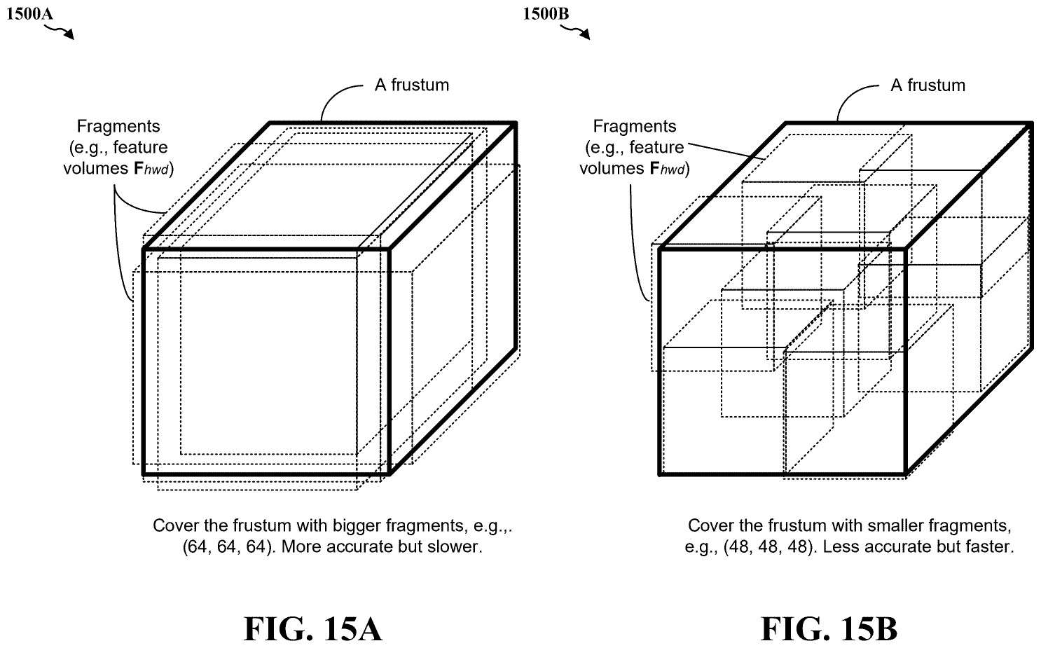

In another aspect of the present disclosure, to increase the processing speed of the backprojection, an edge device (e.g., the edge device 1002, an XR headset, a UE, etc.) may be configured to reduce the number of backprojected voxels for each frame (e.g., each image) by using/tiling smaller fragments (e.g., smaller feature volumes f_{hwd}/F_{hwd}) to cover a big frustum. For example, as shown by a diagram 1500A of FIG. 15A, the edge device may be configured to cover a frustum with a bigger fragment size (e.g., 64×64×64), which may provide a more accurate 3D scene reconstruction but may also take a longer time for processing (e.g., more accurate as there are more overlapping between fragments). On the other hand, as shown by a diagram 1500B of FIG. 15B, if the edge device is configured to cover the frustum with a smaller fragment size (e.g., 48×48×48), while the accuracy of the accurate 3D scene reconstruction may be impacted/reduced, it may also take less time for processing (e.g., less accurate as there are less overlapping between fragments). As such, in some implementations, the edge device may be configured to dynamically adjust the size of the fragment (e.g., the feature volume) based on various conditions to optimize the feature backprojection. For example, the edge device may modify the size of the fragments based on the accuracy, the latency, and/or the power consumption specified by the 3D scene reconstruction. In some examples, the edge device may be configured to use a smaller fragment size for lower latency. In some other examples, the edge device may be configured to use a larger fragment size for higher accuracy.

As described in connection with FIGS. 10 to 12, the edge device 1002 may be configured to perform a recursive feature update based on the stream of posed images 1004. For example, the edge device 1002 may compute a first feature volume based on a first posed image in the stream of posed images 1004, and initialize a recursively updated feature volume with the computed first feature volume. Then, the edge device 1002 may compute a second feature volume based on a second posed image in the stream of posed images 1004, and fuse the computed first second feature volume with the initialized recursively updated feature volume computed second feature volume to obtain the updated feature volume (F_{hwd}). In another aspect of the present disclosure, given a stream of backprojected features (e.g., f_{hwd}), the edge device 1002 may accumulate multi-view feature statistics as the feature volume at a time t. For example, assuming multi-view features in each voxel follows a multivariate normal distribution with a diagonal covariance matrix, the mean Mt and variance St for each feature channel may be accumulated iteratively based on:

$${M}_{0} = 0 , {S}_{0} = 0 , {N}_{0} = 0$$

$${N}_{t} = {N}_{t - 1} + {w}_{t}$$

$${M}_{t} = {M}_{t - 1} + {w}_{t} ( {f}_{t} - {M}_{t - 1} ) / {N}_{t}$$

$${S}_{t} = {S}_{t - 1} + {w}_{t} ( {f}_{t} - {M}_{t - 1} ) ( {f}_{t} - {M}_{t} )$$

$${F}_{t} = [ {M}_{t} , {S}_{t} / ( {N}_{t - 1} ) ]$$

where fₜ is the backprojected feature, wₜ∈{0,1}denotes the voxel visibility, and Nₜ counts visible views. The statistics Fₜ for all features in all voxels may be stacked together and form the feature volume F_{HWD} at the time t. Implementations described in connection with FIGS. 8A and 8B may be configured to accumulate feature mean or variance. However, as both mean and variance may provide useful information, with the same memory budget, aspects described in connection with FIGS. 10 to 13 may specify less computation than just using the mean. In addition, with the same number of feature channels, aspects described in connection with FIGS. 10 to 13 may also specify less memory than just using the variance.

Referring back to FIG. 13, in another aspect of the present disclosure, to improve the efficiency of the TSDF update, the edge device 1002 may be configured to perform an adaptive TSDF update, where the edge device 1002 may update the global TSDF volume (T_{HWD}) given the global feature volume (F_{HWD}) at a time t for just an observed region at an adaptive frequency. For example, the edge device 1002 may be configured to determine the TSDF update scope of the observed region since last/previous update. Assuming TSDF update bound Bₜ is accumulated from feature update bound bₜ:

$${B}_{0} = ∅$$

$${B}_{t} = {B}_{t - 1} ⋃ {b}_{t}$$

When the TSDF volume is updated, the edge device 1002 may reset Bₜ=Ø. In one implementation, the edge device 1002 may be configured to run the TSDF volume update at a maximum frequency of 5 Hz (e.g., updates five times per second). Similarly, the edge device 1002 may perform the TSDF volume update more frequently in the beginning, and less often after the scene is closed to be fully reconstructed (e.g., the reconstruction completeness rate reaches a defined threshold). In some implementations, the edge device 1002 may also be configured to skip TSDF update for regions where features are saturated (e.g., the region is observed but features have subtle changes). In some examples, feature saturation may be measured by changes according to the recursive update |Fₜ−Fₜ₋₁| at the time t.

In another aspect of the present disclosure, in addition to using on a stream of images and its corresponding camera poses obtained from visual(-inertial) odometry (e.g., to obtain the stream of posed images), the edge device 1002 may further improve its performance and 3D scene reconstruction when information related to depth inputs are available. For example, if the edge device 1002 also include the capability to measure the depth of a scene (e.g., an environment, an area, etc.), such as based on using time of flight (ToF) sensors, light detection and ranging (LiDAR), and/or structured light, etc., the edge device 1002 may use the depth information of the scene to perform an efficient learning-based depth estimation. For example, given a stream of depth maps, the edge device 1002 may feed the depth-integrated TSDF volume as an additional input channel for the 3D CNN.

Existing truncated signed distance function (TSDF) integration methods for 3D reconstruction could run fast on edge devices but lack the capability of reasoning in 3D spaces. Neural reconstruction networks, on the other hand, can reason about 3D spaces and produce high-fidelity scene reconstruction but consume more memory and compute, which limits its use on edge devices. Aspects presented herein may improve the overall performance of 3D scene reconstruction on edge devices by enabling a fast high fidelity 3D reconstruction for edge devices. Aspects presented herein may enable an edge device to update a feature within the frustum of each frame to enable stream processing with high frequency. The TSDF is updated for just the observed region at an adaptive frequency. The TSDF update may be more frequent in the beginning and less often after the scene has been fully observed. With the adaptive update configuration, users may be able to observe reconstructed surfaces with low latency while the power consumption remains low. Aspects presented herein may also extend when depth inputs (e.g., depth map/information) are available.

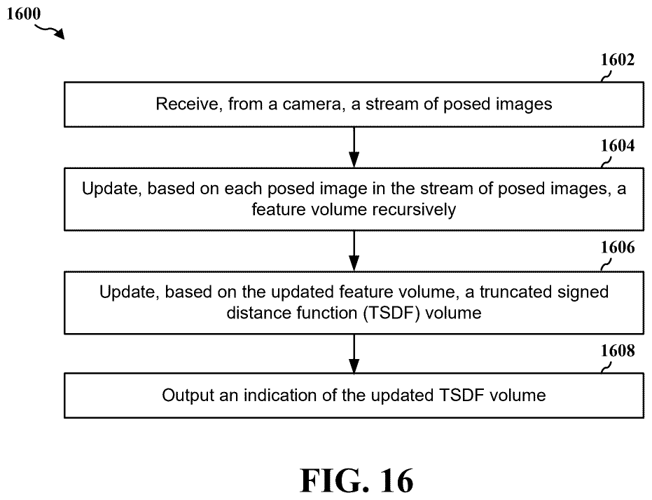

FIG. 16 is a flowchart 1600 of a method of image processing at a user equipment (UE). The method may be performed by a UE (e.g., the UE 104; the XR headset 502; the VR headset 602; the AR/MR headset 702; the edge device 1002; the apparatus 1704). The method may enable the UE to update a feature within the frustum of each frame to enable the processing of a stream of images with high frequency, thereby improving the overall performance of 3D scene reconstruction on the UE.

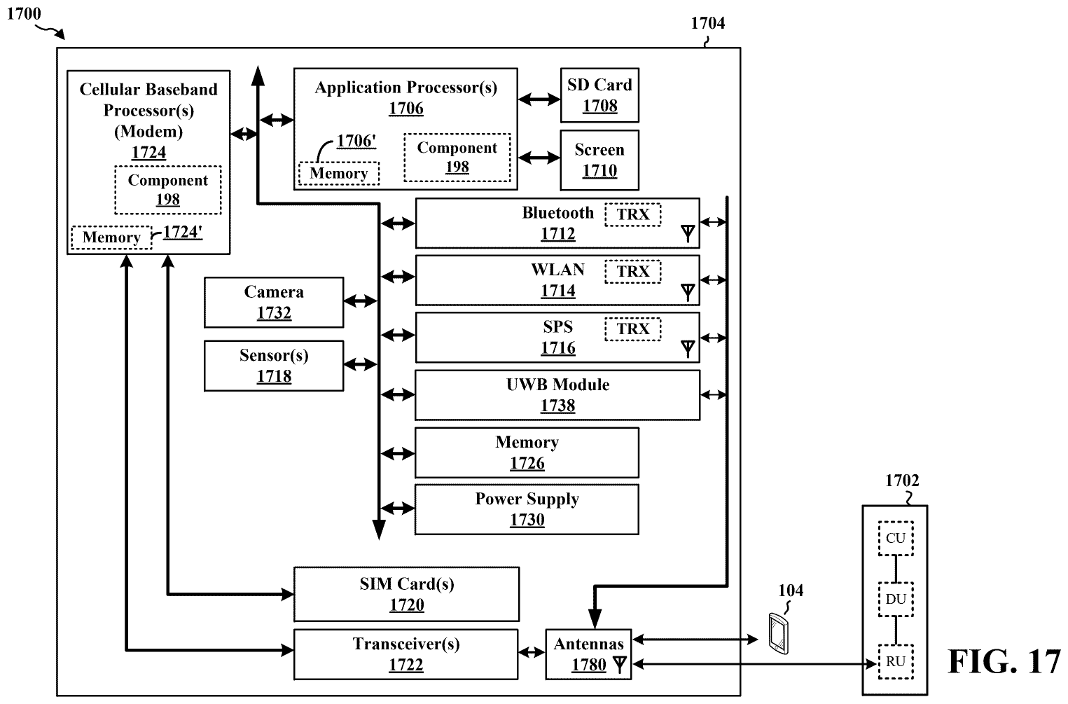

At 1602, the UE may receive, from a camera, a stream of posed images, such as described in connection with FIGS. 10 to 13. For example, as discussed in connection with 1010 of FIG. 10, an edge device 1002 (e.g., an XR headset, a UE, etc.) may be configured to receive a stream of posed images 1004, such as from at least one camera. The reception of the stream of posed images may be performed by, e.g., the scene reconstruction component 198, the camera 1732, the one or more sensors 1718, the transceiver(s) 1722, the cellular baseband processor(s) 1724, and/or the application processor(s) 1706 of the apparatus 1704 in FIG. 17.

At 1604, the UE may update, based on each posed image in the stream of posed images, a feature volume (F_{hwd}) recursively, such as described in connection with FIGS. 10 to 13. For example, as discussed in connection with 1212 of FIG. 12, based on the stream of posed images 1004, the edge device 1002 may update the feature volume (F_{hwd}) recursively (based on running the average and/or the variance). The update of the feature volume may be performed by, e.g., the scene reconstruction component 198, the camera 1732, the one or more sensors 1718, the transceiver(s) 1722, the cellular baseband processor(s) 1724, and/or the application processor(s) 1706 of the apparatus 1704 in FIG. 17.

At 1606, the UE may update, based on the updated feature volume (F_{hwd}), a TSDF volume (T_{hwd}), such as described in connection with FIGS. 10 to 13. For example, as discussed in connection with 1318 of FIG. 13, after the edge device 1002 updates the corresponding feature volume (F_{hwd}) of the global feature volume (F_{HWD}) based on the stream of posed images 1004, the edge device 1002 may use the updated feature volume (F_{hwd}) to update the corresponding TSDF volume (T_{hwd}) in the global TSDF volume (T_{HWD}) (e.g., there may be a one-to-one mapping between F_{hwd}/F_{HWD} and T_{hwd}/T_{HWD}). The update of the TSDF may be performed by, e.g., the scene reconstruction component 198, the camera 1732, the one or more sensors 1718, the transceiver(s) 1722, the cellular baseband processor(s) 1724, and/or the application processor(s) 1706 of the apparatus 1704 in FIG. 17.

At 1608, the UE may output an indication of the updated TSDF volume, such as described in connection with FIGS. 10 to 13. For example, as discussed in connection with 1318 of FIG. 13, the edge device 1002 may output this updated TSDF volume (T_{hwd}), such as performing a 3D scene reconstruction based on the updated TSDF volume (T_{hwd}). In some examples, the edge device 1002 may also transmit and/or store (an indication of) the updated TSDF volume. The outputting of the indication may be performed by, e.g., the scene reconstruction component 198, the camera 1732, the one or more sensors 1718, the transceiver(s) 1722, the cellular baseband processor(s) 1724, and/or the application processor(s) 1706 of the apparatus 1704 in FIG. 17.

In one example, to receive the stream of posed images, the UE may be configured to receive each posed image in the stream of posed images consecutively in time.

In another example, to update the feature volume (F_{hwd}) recursively, the UE may be configured to compute a first feature volume based on a first posed image in the stream of posed images, initialize a recursively updated feature volume with the computed first feature volume, compute a second feature volume based on a second posed image in the stream of posed images, and fuse the computed second feature volume with the initialized recursively updated feature volume to obtain the updated feature volume (F_{hwd}). In some implementations, the UE may further extract a feature image from each posed image in the stream of posed images using a two-dimensional (2D) convolutional neural network (CNN), and construct one feature volume from the feature image extracted from each posed image based on a back projection.

In another example, to update the TSDF volume (T_{hwd}), the UE may be configured to update the TSDF volume (T_{hwd}) using a three-dimensional (3D) convolutional neural network (CNN) with the updated feature volume (F_{hwd}) as an input.

In another example, the feature volume (F_{hwd}) is a portion of a global feature volume (F_{HWD}), and the TSDF volume (T_{hwd}) is a portion of a global TSDF volume (T_{HWD}) that has a one-to-one mapping to the global feature volume (F_{HWD}). In some implementations, the UE may be further configured to determine the portion of the global feature volume (F_{HWD}) to be updated based on a previous update.

In another example, to update the TSDF volume (T_{hwd}), the UE may be configured to update the TSDF volume (T_{hwd}) at an adaptive frequency based on a saturation level of features in the feature volume (F_{hwd}).

In another example, to output the indication of the updated TSDF volume, the UE may be configured to perform a three-dimensional (3D) scene reconstruction based on the updated TSDF volume.

In another example, each posed image in the stream of posed images corresponds to an image taken by the camera and pose information of the camera associated with the image.

In another example, the UE may further be configured to receive a stream of depth maps associated with the stream of posed images, where the TSDF volume (T_{hwd}) is updated further based on the stream of depth maps.

In another example, to output the indication of the updated TSDF volume, the UE may be configured to transmit the indication of the updated TSDF volume, or store the indication of the updated TSDF volume.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include at least one cellular baseband processor 1724 (also referred to as a modem) coupled to one or more transceivers 1722 (e.g., cellular RF transceiver). The cellular baseband processor(s) 1724 may include at least one on-chip memory 1724′. In some aspects, the apparatus 1704 may further include one or more subscriber identity modules (SIM) cards 1720 and at least one application processor 1706 coupled to a secure digital (SD) card 1708 and a screen 1710. The application processor(s) 1706 may include on-chip memory 1706′. In some aspects, the apparatus 1704 may further include a Bluetooth module 1712, a WLAN module 1714, an ultrawide band (UWB) module 1738, an SPS module 1716 (e.g., GNSS module), one or more sensors 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the UWB module 1738, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor(s) 1724 communicates through the transceiver(s) 1722 via one or more antennas 1780 with the UE 104 and/or with an RU associated with a network entity 1702. The cellular baseband processor(s) 1724 and the application processor(s) 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor(s) 1724 and the application processor(s) 1706 are each responsible for general processing, including the execution of software stored on the computer-readable medium/memory. The software, when executed by the cellular baseband processor(s) 1724/application processor(s) 1706, causes the cellular baseband processor(s) 1724/application processor(s) 1706 to perform the various functions described supra. The cellular baseband processor(s) 1724 and the application processor(s) 1706 are configured to perform the various functions described supra based at least in part of the information stored in the memory. That is, the cellular baseband processor(s) 1724 and the application processor(s) 1706 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1724/application processor(s) 1706 when executing software. The cellular baseband processor(s) 1724/application processor(s) 1706 may be a component of the UE 350 and may include the at least one memory 360 and/or at least one of the TX processor 368, the RX processor 356, and the controller/processor 359. In one configuration, the apparatus 1704 may be at least one processor chip (modem and/or application) and include just the cellular baseband processor(s) 1724 and/or the application processor(s) 1706, and in another configuration, the apparatus 1704 may be the entire UE (e.g., see UE 350 of FIG. 3) and include the additional modules of the apparatus 1704.

As discussed supra, the scene reconstruction component 198 may be configured to receive, from a camera, a stream of posed images. The scene reconstruction component 198 may also be configured to update, based on each posed image in the stream of posed images, a feature volume recursively. The scene reconstruction component 198 may also be configured to update, based on the updated feature volume, a TSDF volume. The scene reconstruction component 198 may also be configured to output an indication of the updated TSDF volume. The scene reconstruction component 198 may be within the cellular baseband processor(s) 1724, the application processor(s) 1706, or both the cellular baseband processor(s) 1724 and the application processor(s) 1706. The scene reconstruction component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1704 may include a variety of components configured for various functions. In one configuration, the apparatus 1704, and in particular the cellular baseband processor(s) 1724 and/or the application processor(s) 1706, may include means for receiving, from a camera, a stream of posed images. The apparatus 1704 may further include means for updating, based on each posed image in the stream of posed images, a feature volume recursively. The apparatus 1704 may further include means for updating, based on the updated feature volume, a TSDF volume. The apparatus 1704 may further include means for outputting an indication of the updated TSDF volume.

In one configuration, the means for receiving the stream of posed images may include configuring the apparatus 1704 to receive each posed image in the stream of posed images consecutively in time.

In another configuration, the means for updating the feature volume recursively may include configuring the apparatus 1704 to compute a first feature volume based on a first posed image in the stream of posed images, initialize a recursively updated feature volume with the computed first feature volume, compute a second feature volume based on a second posed image in the stream of posed images, and fuse the computed second feature volume with the initialized recursively updated feature volume to obtain the updated feature volume. In some implementations, the apparatus 1704 may further include means for extracting a feature image from each posed image in the stream of posed images using a 2D CNN, and means for constructing one feature volume from the feature image extracted from each posed image based on a back projection.

In another configuration, to update the TSDF volume may include configuring the apparatus 1704 to update the TSDF volume using a 3D CNN with the updated feature volume as an input.

In another configuration, the feature volume is a portion of a global feature volume, and the TSDF volume is a portion of a global TSDF volume that has a one-to-one mapping to the global feature volume. In some implementation, the apparatus 1704 may further include means for determining the portion of the global feature volume to be updated based on a previous update.

In another configuration, the means for updating the TSDF volume may include configuring the apparatus 1704 to update the TSDF volume at an adaptive frequency based on a saturation level of features in the feature volume.

In another configuration, the means for outputting the indication of the updated TSDF volume may include configuring the apparatus 1704 to perform a 3D scene reconstruction based on the updated TSDF volume.

In another configuration, each posed image in the stream of posed images corresponds to an image taken by the camera and pose information of the camera associated with the image.

In another configuration, the apparatus 1704 may further include means for receiving a stream of depth maps associated with the stream of posed images, where the TSDF volume is updated further based on the stream of depth maps.

In another configuration, the means for outputting the indication of the updated TSDF volume may include configuring the apparatus 1704 to transmit the indication of the updated TSDF volume, or store the indication of the updated TSDF volume.

The means may be the scene reconstruction component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of image processing, comprising, comprising: receiving, from a camera, a stream of posed images; updating, based on each posed image in the stream of posed images, a feature volume recursively; updating, based on the updated feature volume, a truncated signed distance function (TSDF) volume; and outputting an indication of the updated TSDF volume.

Aspect 2 is the method of aspect 1, wherein receiving the stream of posed images comprises: receiving each posed image in the stream of posed images consecutively in time.

Aspect 3 is the method of aspect 1 or aspect 2, wherein updating the feature volume recursively comprises: computing a first feature volume based on a first posed image in the stream of posed images; initializing a recursively updated feature volume with the computed first feature volume; computing a second feature volume based on a second posed image in the stream of posed images; and fusing the computed second feature volume with the initialized recursively updated feature volume to obtain the updated feature volume.

Aspect 4 is the method of any of aspects 1 to 3, further comprising: extracting a feature image from each posed image in the stream of posed images using a two-dimensional (2D) convolutional neural network (CNN); and constructing one feature volume from the feature image extracted from each posed image based on a back projection.

Aspect 5 is the method of any of aspects 1 to 4, wherein updating the TSDF volume comprises: updating the TSDF volume using a three-dimensional (3D) convolutional neural network (CNN) with the updated feature volume as an input.

Aspect 6 is the method of any of aspects 1 to 5, wherein the feature volume is a portion of a global feature volume, wherein the TSDF volume is a portion of a global TSDF volume that has a one-to-one mapping to the global feature volume.

Aspect 7 is the method of any of aspects 1 to 6, further comprising: determining the portion of the global feature volume to be updated based on a previous update.

Aspect 8 is the method of any of aspects 1 to 7, wherein updating the TSDF volume comprises: updating the TSDF volume at an adaptive frequency based on a saturation level of features in the feature volume.

Aspect 9 is the method of any of aspects 1 to 8, wherein outputting the indication of the updated TSDF volume comprises: performing a three-dimensional (3D) scene reconstruction based on the updated TSDF volume.

Aspect 10 is the method of any of aspects 1 to 9, wherein each posed image in the stream of posed images corresponds to an image taken by the camera and pose information of the camera associated with the image.

Aspect 11 is the method of any of aspects 1 to 10, further comprising: receiving a stream of depth maps associated with the stream of posed images, where the TSDF volume is updated further based on the stream of depth maps.

Aspect 12 is the method of any of aspects 1 to 11, wherein outputting the indication of the updated TSDF volume comprises: transmitting the indication of the updated TSDF volume; or storing the indication of the updated TSDF volume.

Aspect 13 is an apparatus for image processing, including: at least one memory; and at least one processor coupled to the at least one memory and, based at least in part on information stored in the at least one memory, the at least one processor, individually or in any combination, is configured to implement any of aspects 1 to 12.

Aspect 14 is the apparatus of aspect 13, further including at least one transceiver or at least one antenna coupled to the at least one processor, wherein to output the indication of the updated TSDF volume, the at least one processor is configured to output the indication of the updated TSDF volume via the at least one transceiver or the at least one antenna.

Aspect 15 is an apparatus for image processing, including means for implementing any of aspects 1 to 12.

Aspect 16 is a computer-readable medium (e.g., a non-transitory computer-readable medium) storing computer executable code, where the code when executed by a processor causes the processor to implement any of aspects 1 to 12.

What is claimed is:

1. An apparatus for image processing, comprising:
at least one memory; and
at least one processor coupled to the at least one memory and, based at least in part on information stored in the at least one memory, the at least one processor, individually or in any combination, is configured to:
receive, from a camera, a stream of posed images;
update, based on each posed image in the stream of posed images, a feature volume recursively;
update, based on the updated feature volume, a truncated signed distance function (TSDF) volume; and
output an indication of the updated TSDF volume.

2. The apparatus of claim 1, wherein to receive the stream of posed images, the at least one processor, individually or in any combination, is configured to:
receive each posed image in the stream of posed images consecutively in time.

3. The apparatus of claim 1, wherein to update the feature volume recursively, the at least one processor, individually or in any combination, is configured to:
compute a first feature volume based on a first posed image in the stream of posed images;
initialize a recursively updated feature volume with the computed first feature volume;
compute a second feature volume based on a second posed image in the stream of posed images; and
fuse the computed second feature volume with the initialized recursively updated feature volume to obtain the updated feature volume.

4. The apparatus of claim 3, wherein the at least one processor, individually or in any combination, is further configured to:
extract a feature image from each posed image in the stream of posed images using a two-dimensional (2D) convolutional neural network (CNN); and
construct one feature volume from the feature image extracted from each posed image based on a back projection.

5. The apparatus of claim 1, wherein to update the TSDF volume (T_{hwd}), the at least one processor, individually or in any combination, is configured to:
update the TSDF volume using a three-dimensional (3D) convolutional neural network (CNN) with the updated feature volume (F_{hwd}) as an input.

6. The apparatus of claim 1, wherein the feature volume is a portion of a global feature volume, wherein the TSDF volume is a portion of a global TSDF volume that has a one-to-one mapping to the global feature volume.

7. The apparatus of claim 6, wherein the at least one processor, individually or in any combination, is further configured to:
determine the portion of the global feature volume to be updated based on a previous update.

8. The apparatus of claim 1, wherein to update the TSDF volume, the at least one processor, individually or in any combination, is configured to:
update the TSDF volume at an adaptive frequency based on a saturation level of features in the feature volume.

9. The apparatus of claim 1, wherein to output the indication of the updated TSDF volume, the at least one processor, individually or in any combination, is configured to:
perform a three-dimensional (3D) scene reconstruction based on the updated TSDF volume.

10. The apparatus of claim 1, wherein each posed image in the stream of posed images corresponds to an image taken by the camera and pose information of the camera associated with the image.

11. The apparatus of claim 1, wherein the at least one processor, individually or in any combination, is further configured to:
receive a stream of depth maps associated with the stream of posed images, where the TSDF volume is updated further based on the stream of depth maps.

12. The apparatus of claim 1, wherein to output the indication of the updated TSDF volume the at least one processor, individually or in any combination, is configured to:
transmit the indication of the updated TSDF volume; or
store the indication of the updated TSDF volume.

13. A method of image processing, comprising:
receiving, from a camera, a stream of posed images;
updating, based on each posed image in the stream of posed images, a feature volume recursively;
updating, based on the updated feature volume, a truncated signed distance function (TSDF) volume; and
outputting an indication of the updated TSDF volume.

14. The method of claim 13, wherein updating the feature volume recursively comprises:
computing a first feature volume based on a first posed image in the stream of posed images;
initializing a recursively updated feature volume with the computed first feature volume;
computing a second feature volume based on a second posed image in the stream of posed images; and
fusing the computed second feature volume with the initialized recursively updated feature volume to obtain the updated feature volume.

15. The method of claim 13, wherein the feature volume is a portion of a global feature volume, wherein the TSDF volume is a portion of a global TSDF volume that has a one-to-one mapping to the global feature volume.

16. The method of claim 15, further comprising:
determining the portion of the global feature volume to be updated based on a previous update.

17. The method of claim 13, wherein updating the TSDF volume comprises:
updating the TSDF volume at an adaptive frequency based on a saturation level of features in the feature volume.

18. The method of claim 13, wherein outputting the indication of the updated TSDF volume comprises:
performing a three-dimensional (3D) scene reconstruction based on the updated TSDF volume.

19. The method of claim 13, further comprising:
receiving a stream of depth maps associated with the stream of posed images, where the TSDF volume is updated further based on the stream of depth maps.

20. A computer-readable medium storing computer executable code, the code when executed by at least one processor causes the at least one processor to:
receive, from a camera, a stream of posed images;
update, based on each posed image in the stream of posed images, a feature volume recursively;
update, based on the updated feature volume, a truncated signed distance function (TSDF) volume; and
output an indication of the updated TSDF volume.
